(19) United States
(12) Patent Application Publication
(10) Pub. No.: US 2022/0111613 A1
(43) Pub. Date: Apr. 14, 2022

(54) PAPER-BASED CUSHION PACKAGE

(71) Applicant: Facebook Technologies, LLC, Menlo Park, CA (US)

(72) Inventor: Derek Pincus, San Francisco, CA (US)

(21) Appl. No.: 17/183,827

(22) Filed: Feb. 24, 2021

Related U.S. Application Data
(60) Provisional application No. 63/091,833, filed on Oct. 14, 2020.

(51) Int. Cl. B32B 3/26; B32B 5/02; B32B 29/00; B32B 3/28; B32B 33/00; B65D 85/68; B65D 81/133

(52) U.S. Cl. CPC B32B 3/263; B32B 5/02; B32B 29/002; B32B 3/28; B65D 2585/86; B65D 85/68; B65D 81/133; B32B 2553/02; B32B 2255/12; B32B 33/00

(57) ABSTRACT

An example disclosed article may include a first layer and a second layer, where the first layer and the second layer may be bonded together within a peripheral region, the first layer and the second layer may be spaced apart within a cushion portion, the peripheral region may extend at least partially around the cushion portion, and the first layer may include cellulose fibers. The article may be used as a component of a packaging arrangement that may be entirely recycled using a paper recycling process. Examples also include, for example, related methods, systems, and assemblies.

### CROSS REFERENCE TO RELATED APPLICATION

This application claims the benefit of U.S. Provisional Application No. 63/091,833, filed Oct. 14, 2020, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-1D show an example cushion package, according to some embodiments.

FIGS. 2A-2B show a further example cushion package, according to some embodiments.

FIG. 3 shows a package assembly including an example cushion package, according to some embodiments.

FIG. 4 shows an electronic device within a package assembly, according to some embodiments.

FIG. 5 shows an example cushion package attached to another package component, according to some embodiments.

FIG. 6 further illustrates an example cushion package attached to another package component, according to some embodiments.

FIG. 7 shows a cross-section of an example cushion package, according to some embodiments.

FIG. 8 shows a cross-section of a cushion portion of an example cushion package, according to some embodiments.

FIG. 9 shows a cross-section an example cushion package including a surface coating, according to some embodiments.

FIG. 10 shows a cross-section an example cushion package including spacer elements, according to some embodiments.

FIG. 11 illustrates an example method of fabricating an example cushion package, according to some embodiments.

FIG. 12 illustrates an example method of packaging a device using an example cushion package, according to some embodiments.

FIG. 13 illustrates an example method of recycling the packaging of an electronic device, according to some embodiments.

FIG. 14 illustrates an example device that may be packaged using an example cushion package, according to some embodiments.

FIG. 15 further illustrates an example device that may be packaged using an example cushion package, according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and are described in detail herein. However, the exemplary embodiments described herein are not intended to be limited to the particular forms disclosed. Rather, the present disclosure covers all modifications, equivalents, and alternatives falling within the scope of the disclosure including the appended claims.

### DETAILED DESCRIPTION OF EXEMPLARY EMBODIMENTS

Consumer electronic devices may be fragile devices with cosmetic surfaces to be protected by packaging through transit environments. Plastic foams are often used to package the complex shapes of consumer devices. However, plastic foams are not consumer recyclable. Also, when foam is adhered to normally recyclable materials, the foam may make the entire assembly non-recyclable. Foams are often considered aesthetically un-appealing and may detract from the general perception of the packaged device, as viewed by an end customer. Paper is a recyclable material. However, conventional paper packaging may fail to protect a packaged device from repeated drops as the paper may naturally crease and tear under load, and the protection may be compromised.

The present disclosure, in contrast, describes various examples of a cushion, such as a paper-based cushion, that may have one or more of the following features. The cushion package may conform to a curved surface of a consumer electronic device and may accommodate complex curvatures. The cushion package may be compliant to a fragile surface. Pressure exerted by the cushion package on a device surface may lead to deformation of one or both layers of the cushion package as opposed to damaging the device. The cushion package may also match the general aesthetic of other paper-based packaging materials and may allow and encourage complete recycling of the packaging materials.

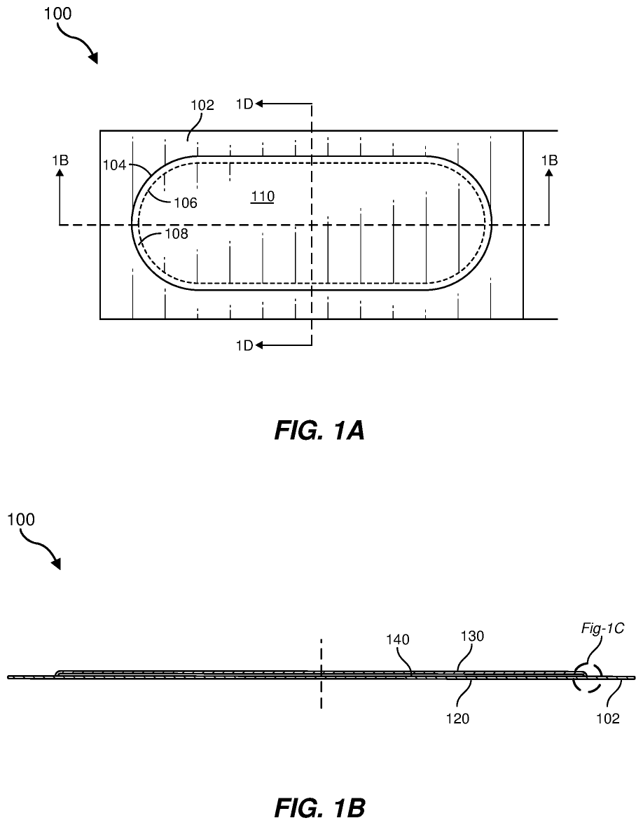

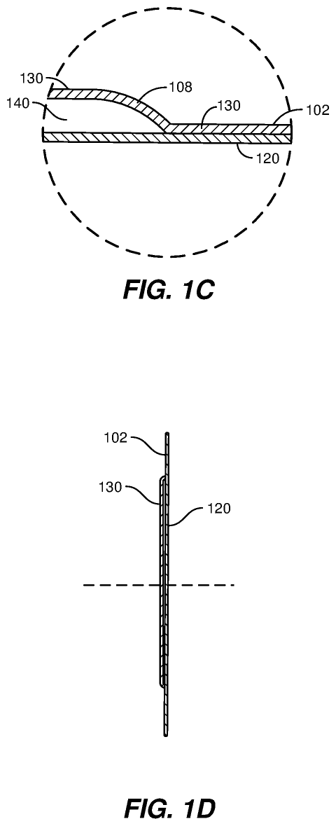

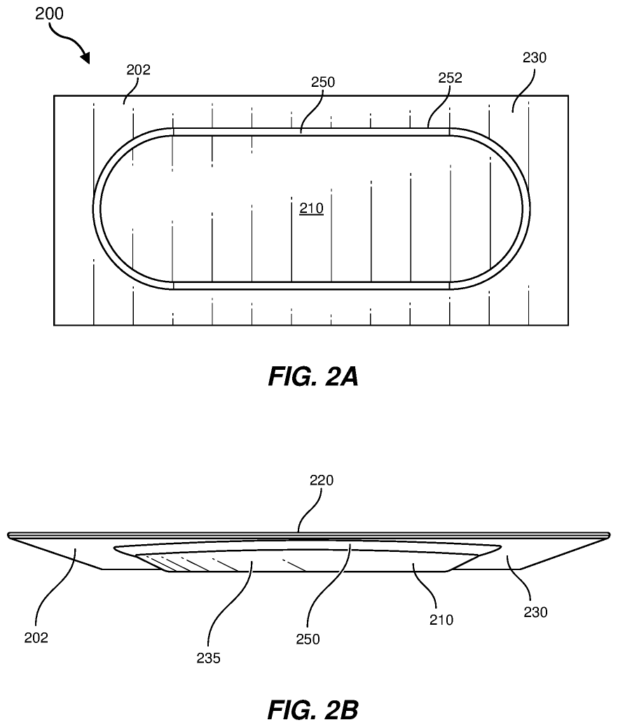

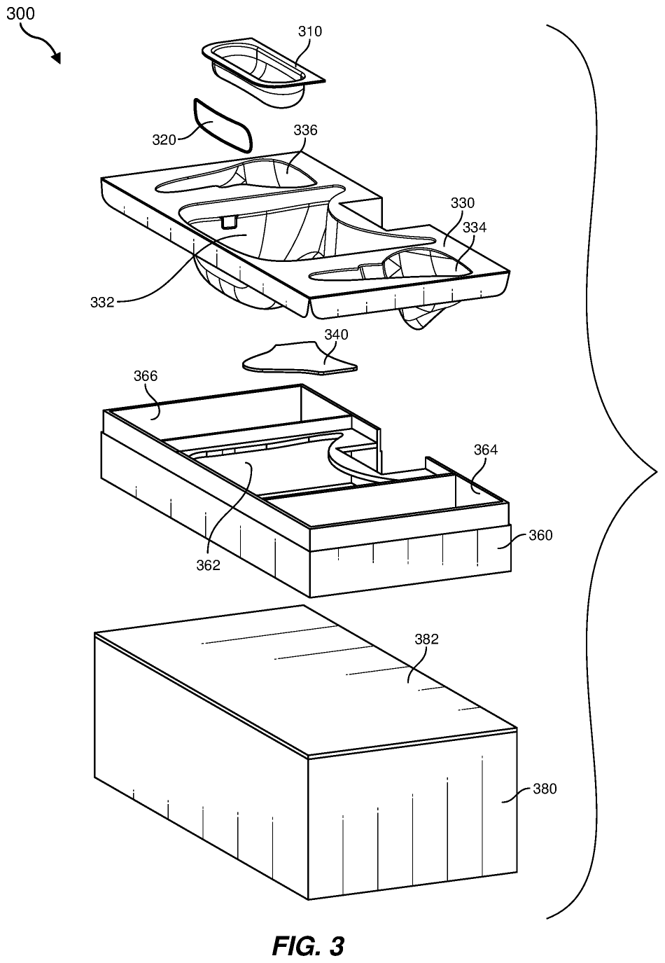

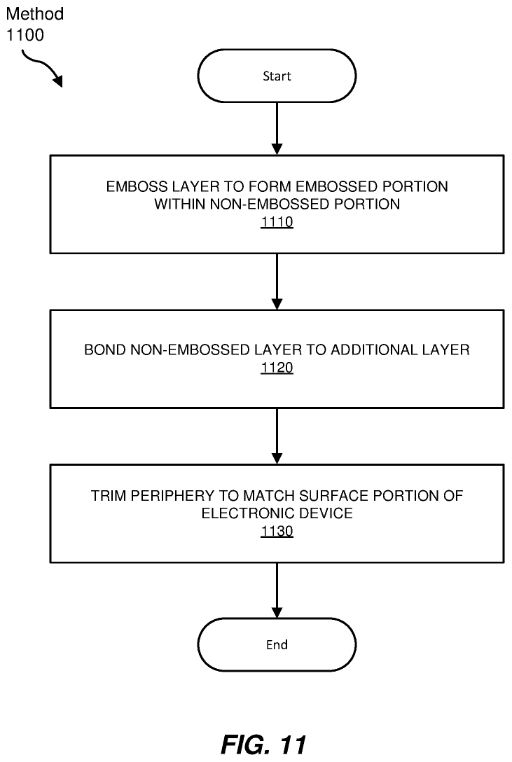

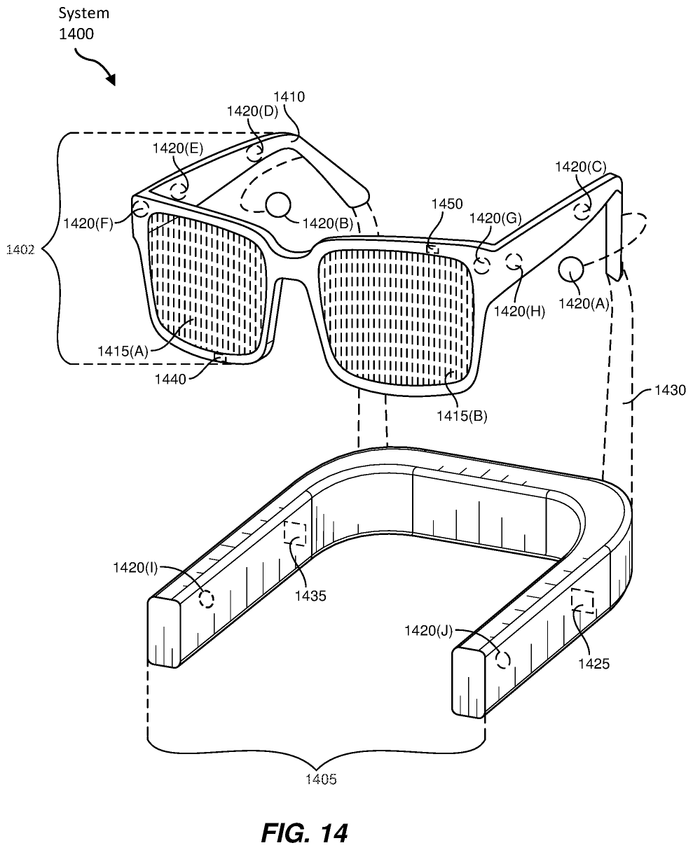

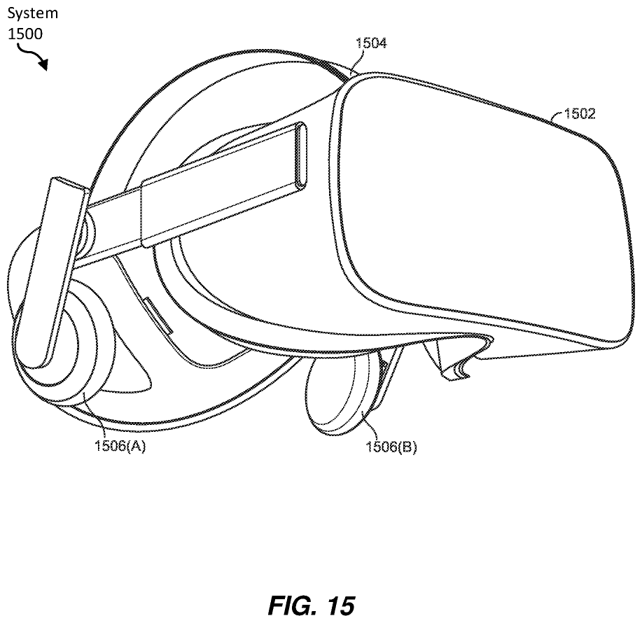

FIGS. 1A-2B show example cushion packages. FIGS. 3-6 illustrate package assemblies, packaging of electronic devices, and possible attachment of a cushion package to other package items. FIGS. 7-10 further illustrate cross-sectional profiles of an example cushion package. FIGS. 11-13 illustrate example methods of fabricating an example cushion package and methods of packaging. FIGS. 14-15 illustrate example devices that may be packaged using an example cushion package.

An example cushion package (sometimes referred to as a cushion for conciseness), such as a paper-based cushion package, may have one or more of the following features. An example cushion package may include two or more layers. For example, first and second layers may enclose a gas-filled enclosure between the pair of layers. The enclosure may be filled with a gas, such as air, nitrogen, or other gas. In some examples, two or more layers may be stacked up, with an enclosure created between adjacent layers. In some examples, the layers may include paper, and in some examples the layers may include paper sheets. The enclosure may be sealed around a peripheral region, for example, around or proximate an edge.

FIGS. 1A-1D show an example cushion package. FIG. 1A shows a cushion package 100 that includes a peripheral region 102, enclosure periphery 104, enclosure side wall 108, and cushion portion 110. The dashed line 106 represents the location where one layer of the cushion package starts to curve back towards the other layer of cushion package.

FIG. 1B shows a cross-sectional view of the cushion package 100, showing that the cushion portion 110 is formed by a first layer 120 and second layer 130, with the cushion portion 110 including the enclosure 140 defined by the gap between the first layer 120 and second layer 130. The enclosure periphery may be demarcated by the location where the first and second layers are bonded together or otherwise attached to each other. The dashed line through the center is a center line.

FIG. 1C shows a detailed view of a portion of the cushion package 100, showing the second layer 130 curving downwards to meet the first layer 120. The first and second layers may be attached (e.g., bonded) to each other within the peripheral region 102. The enclosure 140 may be defined by a gap between the first layer 120 and the second layer 130, and the enclosure may be filled with a fluid, such as air or another gas. The periphery of the enclosure may be defined by enclosure side wall 108, which may be formed by shaped portions of the second layer 130.

FIG. 1D shows an orthogonal cross-section to that of FIG. 1B, having a similar appearance to that of FIG. 1B. The figure shows peripheral region 102, first layer 120, and second layer 130. The cushion package may be used in any orientation within a packaged device. The dashed line through the center is a center line.

In some examples, the first layer may be generally planar, curved in one plane, or curved in two planes. The first layer may be formed from a sheet or roll of material, such as a paper-based material. In some examples, a cushion package may include a generally planar layer and a shaped layer. The shape of the shaped layer may be formed by embossing, which in some examples may be molded, stamped, or formed by another suitable process. The shaped layer may include a non-embossed portion, which may be bonded to the other layer (e.g., a generally planar layer) within the peripheral region, and an embossed portion which may help define an enclosure located between the layers. The peripheral region, in which a pair of layers may be bonded or otherwise attached together, may generally surround one or more cushion portions.

In some examples, the shaped portion of the second layer may be formed by embossing. For example, an initially planar second layer may be embossed to form a shaped portion, which may include a displaced portion of the second layer surrounded by a curved periphery that forms the enclosure side walls of the cushion package. In some examples, after embossing, the second layer may include at least one embossed portion and at least one non-embossed portion. The enclosure may be defined by the first layer and an embossed portion of the second layer. The periphery of the cushion package may be formed by bonding the non-embossed portion of the second layer to the first layer. The terms “first” and “second” may be arbitrary, may be used to distinguish between a pair of layers, and in some examples may be interchanged. For example, in some examples, the embossed layer may be referred to as the first layer and an additional layer may be referred to as a second layer (or vice versa).

FIGS. 2A-2B show a further example cushion package including first and second layers. FIG. 2A shows cushion package 200 viewed from the side of the second layer 230. The cushion package includes cushion portion 210 defined by an embossed portion of the second layer, in this view raised relative to the peripheral region 202 by enclosure side wall 250.

FIG. 2B shows another view of the cushion package, showing first layer 220 (not visible in the view of FIG. 2A) and second layer 230. An enclosure may be formed by a gap between the first layer 220 and an embossed portion 235 of the second layer 230. The first and second layers may be bonded together within the peripheral region 202, which may at least in part surround the cushion portion 210. The cushion portion 210 may be defined by the first layer 220 and an embossed portion of the second layer 230. The enclosure side walls 250 are provided by a portion of the second layer, for example, a periphery of the embossed portion 235 of the second layer 230 that, together with the first layer, forms the cushion portion 210. The outer periphery 252 of the cushion portion may correspond to where the first and second layers are bonded together within the peripheral region 202.

The peripheral region 202 may be formed by bonding the first and second layer directly together. The peripheral region may help seal gas within the cushion portion 210.

A gas-filled enclosure formed between the first and second layers may be at atmospheric pressure with no external pressure applied to the cushion portion. However, an external force that tends to reduce the volume of the enclosure may be resisted by an increased pressure of gas within the enclosure of the cushion portion. The gas pressure may increase with reduced enclosure volume according to well-known gas laws. This increased gas pressure may then tend to restore the enclosure shape to its original volume, while maintaining contact with the product and helping to hold the product securely in place.

FIG. 3 shows a package assembly including an example cushion package 320. The package assembly 300 includes a box 380, having a box lid 382. The box lid 382 may be opened to place items inside the box, and may include a tensioned lid tongue to help retain the lid in a closed configuration. The package assembly 300 further includes product support 360 configured to fit inside the box 380, having exterior walls 364 and 366, and interior walls such as interior wall 362. A device receptacle 330 is configured to sit inside the product support 360, and includes central compartment 332, and side compartments 334 and 336. An electronic device (not shown in this figure), such as an AR/VR device, may be placed within the central compartment 332, and accessories (e.g., device controllers) associated with the electronic device may be placed within the side compartments 334 and 336.

The cushion package 320 may be attached to a portion of the device receptacle, for example, proximate a surface portion of the electronic device. The cushion package may protect the surface portion from scratching, abrasion, loss of glossy appearance, scuffing, or other degradation of appearance and/or function.

The package assembly 300 may include one or more additional elements, such as top portion 310. The top portion 310 may help secure an electronic device within the central compartment when inside the box 380. For example, the top portion may be located between the electronic device (not shown) and the box lid 382, when the package assembly and the electronic device are assembled and the box lid 382 is closed.

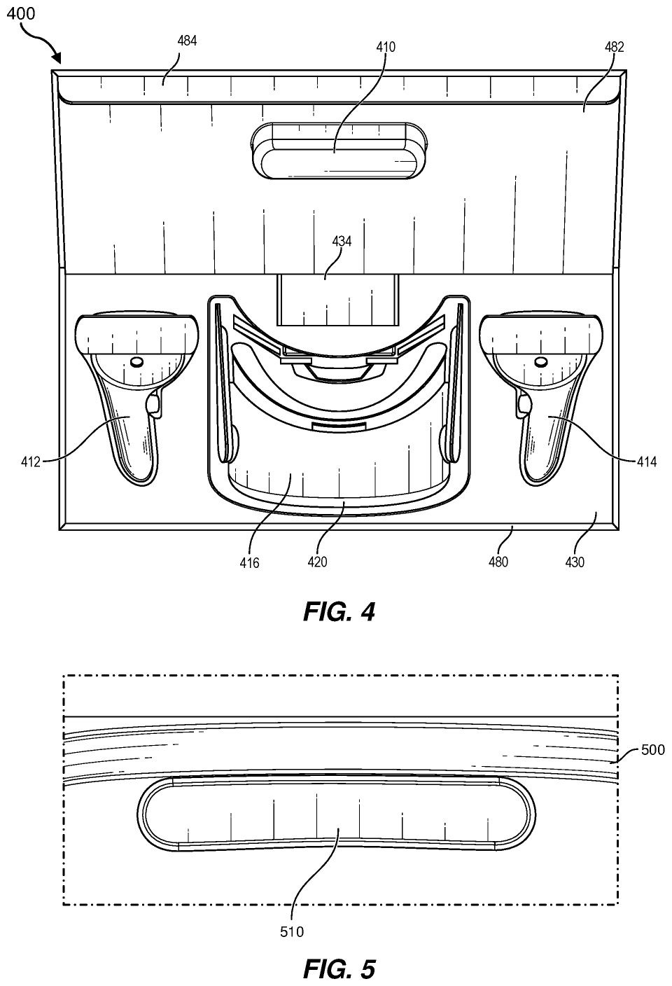

FIG. 4 shows an electronic device within a package assembly shown generally at 400, according to some embodiments. The package assembly 400 includes device receptacle 430 received within box 480. An electronic device 416 and associated device controllers 412 and 414 are located within central and side compartments (respectively) of the device receptacle 430. In this example, the cushion package 420 protects a front surface portion of the electronic device 416, in this example a virtual reality headset. The device receptacle 430 may include recess 434. The box 480 has a box lid 482, shown in an open configuration to show components of the enclosed packaging arrangement. A top portion 410 may be attached to the box lid 482, and may be located between the electronic device 416 and the box lid 482, when the electronic device 416 is placed in the package assembly 400 and the box lid 482 is closed. A tensioned lid tongue 484 may help retain the lid in a closed configuration.

In some examples, an electronic device may have a surface portion that may be protected by the cushion package 420. For example, the cushion package may be adhered to the surface portion, for example, by a contact adhesive. The cushion package may be removed from the surface portion without leaving a residue. In some examples, a cushion package may be held in place at least in part by frictional and/or compressive forces between the surface portion of the electronic device and a component of the package assembly, such as a side wall of a compartment within a device receptacle.

FIG. 5 shows an example cushion package attached to another package component. In this example, the cushion package 510 may be adhered to a portion of the device receptacle 500, for example, to a portion of a central compartment configured to receive an electronic device. The cushion package 510 may be curved to conform with the portion of the device receptacle and with the surface portion of the electronic device (e.g., a curved visor of a virtual reality headset).

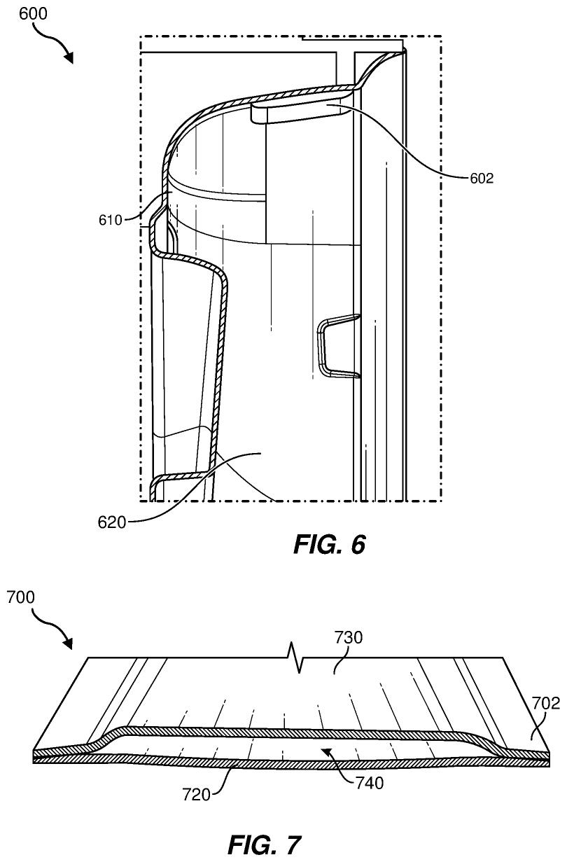

FIG. 6 further illustrates a portion of an example package assembly 600, including a cushion package 602 attached to another package component 610. The package component may be a device receptacle having one or more compartments (such as compartment 620) configured to receive an electronic device and/or device accessory. Adhesion of the cushion package 602 to the compartment 620 may help maintain the package component substantially adjacent a surface portion of the electronic device for which protection is desired.

In some examples, device receptacle and/or one or more other components of the package assembly (e.g., a box) may include a molded item, such as a molded fiber tray, such as a molded paper-based item.

FIG. 7 shows a cross-section of an example cushion package 700, including first layer 720 and second layer 730, having a peripheral region 702 and a cushion portion due to the air gap 740 between the first layer 720 and second layer 730. The first and second layers 720 and 730 may each be generally uniform layers, and may each include cellulose fibers, such as derived from recycled paper, wood (e.g., wood pulp), and/or plant material.

In some examples, a layer may have, or be a part of, a multi-component structure. For example, a layer may support a coating on at least a portion of one or both sides of the layer. In some examples, there may be an adhesive between the layers within a peripheral region of the cushion package.

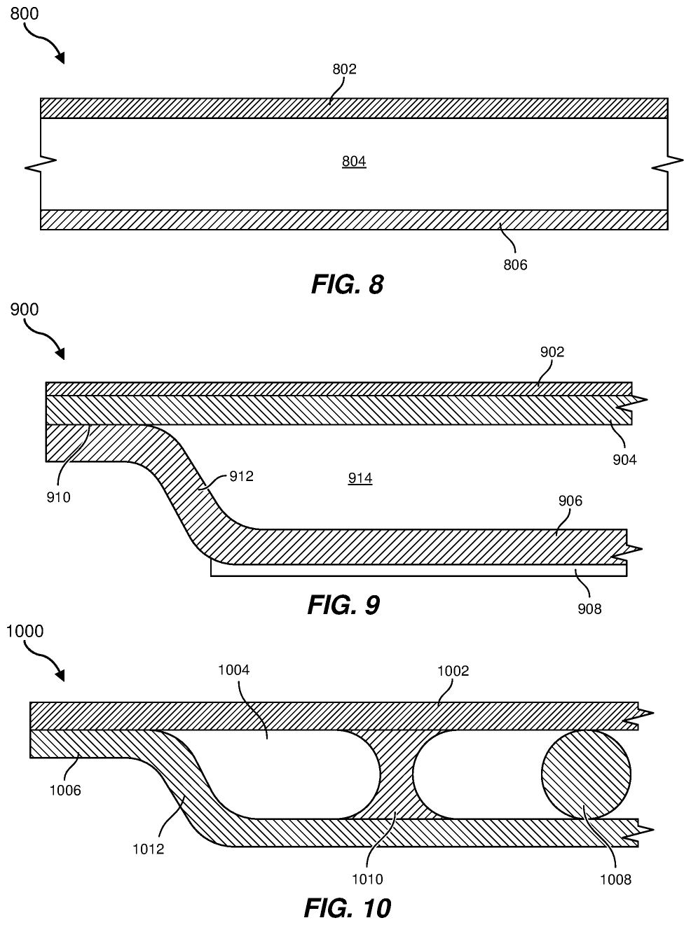

FIG. 8 shows a cross-section of a cushion portion of an example cushion package. The cushion portion 800 may include a first layer 802, a gap 804, and a second layer 806. The cushion portion may include an enclosure, formed by the gap 804 between the first and second layers. The enclosure may be filled with a gas, such as air, nitrogen, carbon dioxide, or an inert gas such as argon.

FIG. 9 shows a cross-section of a portion of a cushion package 900. The cushion package 900 may include a first coating 902, first layer 904, gap 914, second layer 906, and second coating 908. The gap may be filled with a gas, such as air. In some examples, the second coating may extend over most or all of the second layer. The first and second layers may be bonded together where their interior surfaces are in contact at 910, which may define the peripheral region. Enclosure side wall 912 may be formed by a curved portion of the second layer 906, which may be formed by embossing or other suitable process.

In some examples, a coating may be located on at least a portion of the first layer and/or at least a portion of the second layer. In some examples, a coating may act as an anti-scuff layer. In some examples, the coating may include a polymer, such as a polyolefin polymer.

FIG. 10 shows a cross-section of a portion of an example cushion package 1000. The cushion package includes a first layer 1002, a gap 1004, and a second layer 1006. The gap 1004 may include spacer elements such as space element 1008 or spacer element 1010. An enclosure may be defined at least in part by the interior surfaces of the first and second layers (the surfaces that face the gap), and also the enclosure side walls 1012 that may be formed by a curved portion of the second layer 1006.

In some examples, the gap may have a generally uniform gap thickness over the extent of the cushion portion. This may be achieved using the mechanical properties of the layers, which may tend to form a uniform gap between the layers within the cushion portion.

In some examples, a spacer element may be used to maintain a more spatially uniform gap thickness. For example, the gap may include a plurality of spacers that help provide a generally uniform gap thickness. A spacer may be adhered to one or both of the inside surfaces of the layers, or may be free to move within the gap. A spacer may include a sphere (e.g., a bead like spacer), a cylindrical form (e.g., a rod, thread, or other elongated shape), a prism (e.g., a triangular, square, pentagonal, hexagonal, or other cross-sectioned elongated prism), or other form. A spacer may include a bead or other form of glue or other adhesive or bonding agent. In some examples, a spacer may be generally rigid. In some examples, a spacer may be generally elastic and/or resilient, and may appreciably deform under an external force but then urge the gap thickness back to the original thickness after, for example, an external force is removed.

An example manufacturing method for a cushion package may include one or more of the following aspects. A first layer may be embossed to create a curved a portion within the first layer, such as a depression within a central portion of the layer. The embossing step may be performed by a mechanical press. A second layer may be placed over the first layer, forming an enclosure between the curved portion of the first layer and the second layer. The second layer may be generally planar, but in some examples a curved portion may also be formed in the second layer. The two layers may be joined around a peripheral region (such as around an edge, or proximate an edge) to form an enclosure between the two layers. The layers may be joined by any suitable sealing method, such as a high frequency sealing process, adhesion (e.g., contact adhesion), or any other suitable method. The two layers may then together enclose a volume of gas, such as air, within the enclosure. The peripheral region may be cut, trimmed, or otherwise adjusted to achieve a desired shape. For example, die-cutting of the perimeter of the sealed pocket may be used to form the final shape.

FIG. 11 illustrates an example method of fabricating an example cushion package. Example method 1100 may include embossing a layer to form an embossed portion of the layer within an non-embossed portion (1110), bonding the non-embossed portion to an additional layer to form a cushion portion between the embossed portion and the additional layer (1120), and trimming the periphery of the cushion package to match that of a device surface portion to be protected (1130). The cushion portion may include a gas-filled enclosure defined by the interior surfaces of the layer and additional layer, and the periphery of the enclosure (and hence the cushion portion) may be defined by a peripheral region in which the layers are bonded together.

Layers may be bonded together using any appropriate method, for example, using an adhesive or other method of attaching the layers together.

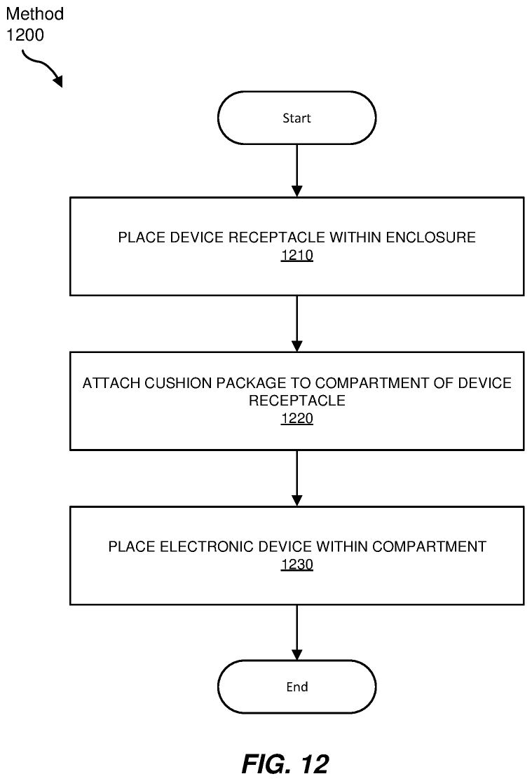

FIG. 12 illustrates an example method of packaging a device using an example cushion package. Example method 1200 may include placing a device receptacle within an enclosure (1210), attaching a cushion package to a compartment of the device receptacle (1220), and placing an electronic device within the compartment (1230) so that the cushion package protects a surface portion of the electronic device. The enclosure may be a box, such as a cardboard box. In some examples, the combination of the enclosure, device receptacle, and cushion package may be recycled together within a paper recycling process.

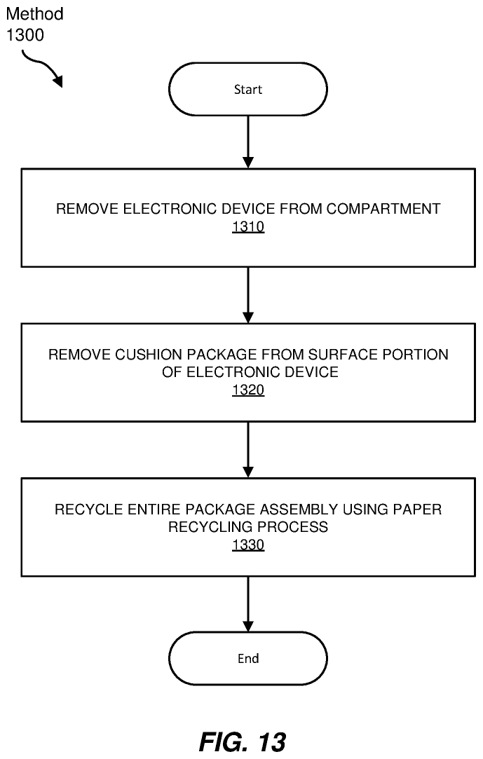

FIG. 13 illustrates an example method of recycling the packaging of an electronic device, according to some embodiments. Example method 1300 may include removing an electronic device from a compartment of a package assembly (1310), removing a cushion package from a surface portion of the device (1320); and recycling the entire package assembly using a paper-based recycle process (1330). In some examples, that the cushion package doesn't need to be removed from the device prior to entering the recycling process, as the cushion package may be adhered to the package assembly or a component thereof. When the device is removed from the package assembly, the cushion package may remain adhered to the package assembly. In some examples. the package assembly (including the cushion package) may be recycled in its entirety within a paper recycling process without needing to remove any component. The package assembly may include less than a predetermined percentage (such as less than 1%, e.g., less than 0.5%) by weight of materials not recyclable within a paper recycling process.

FIG. 14 illustrates an example device 1400 that may be packaged using an example package assembly as described herein, for example, using a package assembly including cushion package. In some examples, the device may be an augmented-reality system. Device 1400 may include an eyewear device 1402 including a frame 1410 configured to hold a left display device 1415(A) and a right display device 1415(B) in front of a user's eyes when the device is worn by a user. Display devices 1415(A) and 1415(B) may act together or independently to present an image or series of images to a user. Device 1400 may also include a microphone array with a plurality of acoustic transducers 1420(A)-1420(J), which may be collectively referred to as acoustic transducers 1420. Device 1400 may include one or more sensors, such as sensor 1440. Sensor 1440 may generate measurement signals in response to motion of the device 1400 and may be located on substantially any portion of frame 1410. The plurality of acoustic transducers may include acoustic transducers 1420(A) and 1420(B) which may be designed to be placed inside a corresponding ear of the user, and acoustic transducers 1420(C), 1420(D), 1420(E), 1420(F), 1420(G), and 1420(H), which may be positioned at various locations on frame 1410, and/or acoustic transducers 1420(1) and 1420(J), which may be positioned on a corresponding neckband 1405. Neckband 1405 may also include a controller 1425 and a power source 1435. In some embodiments, acoustic transducers 1420(A) and 1420(B) may be connected to augmented-reality system 1400 via a wired connection 1430. An associated controller 1450 may be used process the collected audio and/or other sensor information.

FIG. 15 illustrates a further example device that may be packaged using an example cushion package. In this example, device 1500 is virtual-reality system that may mostly or completely covers a user's field of view. Device 1500 includes a front rigid body 1502 and a band 1504 shaped to fit around a user's head. Device 1500 may also include output audio transducers 1506(A) and 1506(B). Front rigid body 1502 may include one or more additional electronic elements (not shown), such as one or more electronic displays, one or more inertial measurement units (IMUS), one or more tracking emitters or detectors, and/or any other suitable device or system for creating an artificial-reality experience.

A device may include a front-facing portion when the device is worn by a user. The front-facing portion may be located in front of the eyes of the user. The front-facing portion may include a surface portion through which external light (or real world light) may enter the device, and/or which may be prominently visible to other people. The appearance and/or function of the device may be reduced in perceived quality by degradation of the surface portion. In some examples, the surface portion may be protected by a cushion package, such as a cushion package as described herein.

In some examples, a device may include two displays, which may be termed a left display and a right display, or a single display. A device may include one or more displays, elements that receive external light from the environment, and optical systems configured to combine image elements from the environment with augmented reality image elements provided by one or more displays. One more device displays may be protected by a cushion package.

In some examples, a device may include a single NED (near-eye display), two NEDs, or more than two NEDs. In some examples, a device may include one or more transducers (such as one or more sensors), such as an inertial measurement unit (IMU), microphone or speaker, optical sensor (e.g., camera or other image sensor, depth camera assembly, or structured light detector), light-emitting device (e.g., light-emitting diode, laser, or structured light emitter), motion sensor (e.g., an accelerometer), gyroscope, magnetometer, or any combination thereof. In some examples, a device may include one or more IMUs, and an example IMU may generate calibration data based on measurement signals from one or more sensors. One or more sensors may be used for error correction of the IMU. Acoustic transducers may include transducers that detect air pressure variations induced by sound waves, and may detect sound and convert the detected sound into an electronic format (e.g., an analog or digital format). One or more transducers, such as one or more sensors, may be protected by at least one cushion package.

Devices may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. Devices may include a single display screen for both eyes or may provide a single display screen having portions viewed each eye, which may allow for additional flexibility for varifocal adjustments or for correcting a user's refractive error. Devices may also include optical subsystems having one or more lenses (e.g., conventional concave or convex lenses, Fresnel lenses, adjustable liquid lenses, etc.) through which a user may view a display screen. These optical subsystems may have one or more functions, such as collimation, magnification, or relaying light to a destination, such as the eyes of a user. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion). One or more displays may be protected by at least one cushion package.

In addition to or instead of using display screens, a device may include one or more projection systems, such as micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays. One or more optical systems, such as one or more projection systems, may be protected by at least one cushion package.

As detailed above, a paper-based cushion package may include a pair of paper-based layers sealed around a peripheral region to form a gas-filled enclosure, which may be termed the cushion portion of the cushion package. A paper-based cushion package may also include a fluid-filled enclosure, which may also be termed a fluid-filled cushion or fluid-filled pillow. The fluid may include a gas, such as air. In some examples, a fluid may include a foam, an emulsion, or other fluid phase. An example cushion package may include an air-filled enclosure that may be formed by sealing an embossed layer to an additional layer, for example, by bonding an embossed paper layer to an additional paper layer. The two layers may be bonded together within a peripheral region corresponding to a non-embossed portion of the layer, forming an enclosure formed at least in part by the embossed portion of the layer and the additional layer.

An example cushion package may provide a compliant interference fit to the 3D external curvature of a packaged consumer product, such as an electronic device or ophthalmic device. The cushion package may reduce movement of the product in transit, and/or may prevent scratching of one or more external surface portions of the consumer product. In some examples, stiffer sidewalls created through tight curvature may create a center hammock-like configuration to help secure the device.

In some examples, one or both layers may include a coating on one or both sides. For example, a layer may have a polymer coating, which may have one or more functions such as reducing the rate of gas diffusion out of the enclosure (e.g., under an external force), reducing scratching and/or scuffing of the device surface, reducing surface energy that may help prevent scuffing of the device surface, or presenting an attractive exterior to a consumer (e.g., a textured surface, or a surface having printed alphanumerical or graphic elements).

In some examples, the coating may include a polymer coating, which may include one or more polymers, such as a polyolefin. Example polyolefins include polyethylene (such as low density polyethylene), or polypropylene. In some examples, a coating may include polyethylene terephthalate. In some examples, a layer may include a polymer-coated paper, and a polymer coating may be formed on one or both sides of the paper.

In some examples, a polymer coating may be thinner than those used in food packaging. The polymer coating may be configured to break apart and/or delaminate from the remaining layer materials during a pulping process, for example, during a paper recycling process. In some examples, a polymer coating may have a coating thickness of less than approximately 100 microns, such as a coating thickness of between approximately 1 micron and approximately 100 microns. In some examples, a polymer coating, such as a polypropylene coating, may have a coating thickness of between 5 microns and 50 microns.

In some examples, a coating, such as a polymer coating, may be laminated onto (or otherwise formed on) at least a portion of one or both sides of the first layer and/or the second layer. In some examples, a coating may be formed by forming a film of polymerizable material on at least one surface of the layer, then polymerizing the film. In some examples, a polymer coating may be attached to one or both surfaces of the layer using an adhesive.

In some examples, the cushion package may have an external surface, viewable when opening the package, that may enhance the visual perception of the packaged device. The external surface may have a textured surface, a color, a general aesthetic that may be associated with a manufacturer of the device, or an appearance of recyclability (e.g., retaining the appearance of paper of conveying a visual indication of recyclability.

In some examples, a cushion package may have a natural, recycled-paper appearance. In some examples, a cushion package may have one or more of a color or surface texture that is modified, for example, for functional or aesthetic purposes. For example, a cushion package may be colored black, which some may consider stylish, and/or may be colored to match other package assembly components. In some examples, a cushion package may be configured with a smooth, matte, or otherwise textured appearance. Surface texture may be provided by a textured coating and/or embossing or other surface profiling of the cushion package. For example, a textured coating may include a textured polymer coating, and/or may include a surface profile that modifies the reflection properties of the surface. For example, a polymer surface coating may include a surface profile including grooves and/or protrusions. A surface profile may include an arrangement of parallel grooves, in some examples having a depth and/or spacing of between 300 nm and 1 mm. In some examples, a surface profile may provide visual enhancement of spectral components, for example, due to optical interference of viewed reflections. In some examples, the coating may have a grooved external surface profile that may provide a diffractive or lustrous external optical appearance.

In some examples, a layer may include a laminated surface, and may include a plastic film laminated to a paper sheet. In some examples, a layer (e.g., a paper sheet) may be treated with a polymer vapor, a monomer vapor, melted polymer, or otherwise coated or otherwise treated with one or more polymers. A coating may include a UV (ultraviolet) polymerized component and/or a cross-linked component. In some examples, a layer may include a laminated polymer coating, such as a polypropylene (PP) laminated surface. Polymer lamination (e.g., over a surface of the cushion package in contact with the device) or other polymer coating may help reduce the surface energy of the surface of the cushion package, and/or may help prevent scuffing or scratching of the device surface.

In some examples, a paper-based cushion package may allow the complete set of packaging materials (the package assembly, which may include a molded fiber tray such as a device receptacle) to remain paper-recyclable in a consumer waste stream.

In some examples, a cushion package (e.g., including a paper-based material) may include cellulose fibers derived from wood (or from other plant materials, such as grasses). In some examples, a cushion package (e.g., including a paper-based material) may include wood-product-based paper, rag paper (e.g., cotton-derived paper), paper including polymer fibers, or other paper materials. In some examples, a cushion package may include other natural fibers, such as cotton fibers or other plant-derived fibers, such as cellulose fibers.

In some examples, one or both of the layers may be (or include) polymer layers, such as polyolefin layers. An example layer may include one or more recyclable polymers, such as a cellulose polymer or other polymer that may be recycled within a paper recycling process. In some examples, a thin polymer layer (e.g., a polyolefin layer or water-soluble polymer layer) may be removed from a layer by hot water exposure or other process, allowing the layer to be then recycled in a paper recycling process. In some examples, a polymer coating may be at least partially soluble in hot water, facilitating removal from the paper-based components. In some examples, a polymer coating may be recyclable with paper based components, and may include a plant derived polymer such as cellulose, a cellulose derivative such as rayon, or other polymer suitable for inclusion in a paper recycling process.

In some examples, a method may include removing a device (e.g., an electronic device) from a package assembly including a box, a device receptacle, and a cushion package. This may include removing the cushion package from a surface portion of the device. For example, the cushion package may be electrostatically attracted to the surface portion. In some examples, the surface portion may be generally smooth, may be glossy, and may include a light-receiving surface of the device. An example method may further include recycling the entire package assembly, including the cushion package, using a paper-based recycle process. This may be performed without removing a synthetic polymer component from the package assembly.

In some examples, a cushion package may be recyclable using a paper recycling process. In some examples, the weight of polymer within the cushion package may be less than 1%, the remaining material being recyclable using a paper recycling process. In some examples, an entire package assembly (e.g., including a box, a device receptacle, and a cushion package) may be recyclable using a paper recycling process. In some examples, one or more components of the package assembly (e.g., the box) may include a corrugated construction. In some examples, the entire package assembly (e.g., including a box, a device receptacle, and a cushion package) may include less than 1% by weight of non-recyclable polymer (e.g., less than 1% of a synthetic polymer such as a polyolefin film that may not be economic to recycle from the package assembly). In some examples, the package assembly may not include any appreciable amount of synthetic polymer foam.

In some examples, the package assembly may include 50% or more recycled content, may be at least 99% consumer recyclable, or, in some examples, may be entirely consumer recyclable (including the cushion package).

A paper recycling process may include forming a pulp (or slurry) of paper-based fibers within a vat of liquid, such as water. The water may be heated. In some examples, the polymer coating may be one or more of broken up, dissolved, or separated from the paper-based layers during the recycling process. Non-water soluble polymers and other components may be separated from the pulp using a screen.

In some examples, a cushion package (or other article of manufacture) may include a first layer and a second layer, where the first layer and the second layer define an enclosure located between the first layer and the second layer, and the enclosure is gas filled. One or both of the first layer and the second layer may include paper. In this context, paper may include a thin sheet including cellulose fibers. In some examples, a cushion package may include a first layer and a second layer, where the first layer and the second layer define an enclosure located between the first layer and the second layer, and the enclosure is gas filled. One or both of the first layer and the second layer may include paper, such as a sheet of paper or card, or a paper-based material. In this context, a paper-based material may include cellulose fibers.

The first and/or second layer may have a layer thickness and a layer width. The layer thickness may be between 0.05 mm (50 microns) and 5 mm, such as between 0.05 mm and 2 mm. In some examples, the layer thickness of the first and/or second layer thickness may be between 0.1 mm (100 microns) and 2 mm. In some examples, the first layer thickness may be approximately equal to the second layer thickness. A layer thickness may be determined near a center of the cushion package, within a peripheral region, as an average thickness, or as any other suitable dimension. A layer thickness may be determined along a direction locally normal to one or both of the layers.

In some examples, a cushion package (or a layer thereof) may have a width and a length. The width may be generally orthogonal to the length, but the designation may be arbitrary. In some examples, the length may be considered to be the longer dimension, though this is not limiting. In some examples, the width may be a dimension generally within the plane of a layer, or may be measured along a direction conforming with a curvature of the layer. The layer width may be in the range of between 2 cm and 50 cm, such as between 5 cm and 30 cm. In some examples, the layer width may be at least 10 times the layer thickness, and in some examples, may be at least 20 times the layer thickness, such as at least 100 times the layer thickness. The shape of the cushion package may be generally rectangular, optionally with rounded corners, or in some examples, may be irregular (e.g., to match the outline of spectacles). Other shapes may be used, such as oval, elliptical, round, eye-lens shape, or other suitable shape.

In some examples, a cushion package may have an outer periphery that matches the shape of a surface portion of a device, such as the shape of eyeglasses, a visor, or that of an augmented reality or virtual reality device.

In some examples, the gap thickness (or spacing) between the layers may be in the range of approximately 0.5 mm and approximately 10 mm, for example, between approximately 1 mm and approximately 5 mm.

In some examples, the thickness of the cushion portion (or cushion thickness) of a cushion package may include the thickness of first and second layers, the gap thickness, and the thickness of any applied surface coating(s). In some examples, the cushion thickness may be between 2 mm and 10 mm, such as between 3 mm and 8 mm. In some examples, the thickness of the peripheral region include the thickness of the first and second layers, along with any applied surface coating(s) or adhesive layer between the first and second layers. The peripheral region may thinner than the cushion portion. In some examples, the peripheral portion may be between 0.5 and 8 mm.

In some examples, an aspect ratio of the enclosure (e.g., a ratio of a lateral dimension to the layer spacing in the absence of an external force), or an aspect ratio of a cushion package (e.g., a ratio of the cushion thickness to the height or width or the cushion package) may be at least 10, at least 20, at least 50, or at least 100. An aspect ratio for the enclosure may be the ratio of the gap thickness (or layer spacing) to the longest or shortest of the lateral dimensions of the enclosure. The aspect ratio may be determined for a cushion package in a generally planar configuration. If the cushion package is curved, the lateral dimension may be measured along a direction that conforms to the curvature. The lateral dimension may be along a direction normal to the layer thickness. Similarly, an aspect ratio of the cushion package may be determined in a generally planar configuration, or estimated for a curved configuration. In some examples, an aspect ratio for the cushion package, in terms the ratio of the cushion thickness to a height or width (or other suitable dimension) of the cushion package, may be at least 20.

In some examples, one or both layers may include a coating layer on one or both sides. Layers may be adhered together using an adhesive layer, or any other suitable bonding technique.

In some examples, the cushion package may have an outer peripheral region that is shaped in a manner similar to a surface portion of a device such as an AR/VR (augmented reality and/or virtual reality) device, ophthalmic device such as eyeglasses, a visor, or any other apparatus. The outer profile of the peripheral region of an example cushion package may match that of a surface portion of the device that may be provided with additional protection. The cushion package may be placed over at least a portion of the external surface of eyewear and/or a head-mounted device, for example, to protect portions of the device through which a person may look through during normal operation of the device. The cushion package may be used to package an augmented reality device or a virtual reality device, and may be sized to cover a surface portion of a head-mounted device.

In some examples, a cushion package may include a single cushion portion. In some examples, a cushion package may include a plurality of cushion portions, for example, a first cushion portion configured to cover a first lens (or first surface portion) and a second cushion portion configured to cover a second lens (or second surface portion).

In some examples, the cushion package may include spacers within the enclosures. Spacers may be adhered to one or both of the layers. Spacers may include beads (such as polymer beads), adhesive droplets, folded (e.g., multiply-folded, or concertina-like) paper elements, or other elements. In some examples, a spacer may be formed by a structure formed in a polymer coating, or an element bonded to a polymer coating. In some examples, a spacer may include a bead, pillar, ridge, wedge, or other shaped element. In some examples, spacers may be formed by fusing or otherwise adhering together one or more structures formed in the polymer coatings on the inner surfaces of the layers. In this context, inner surfaces may be adjacent or substantially adjacent the enclosure. In some examples, a polymer coating may be recyclable with paper and may, for example, include a cellulose based polymer.

In some examples, the cushion package may be used to package a consumer electronic device. A method of packaging may include placing the consumer electronic device in a molded paper receptacle, and placing a cushion package over an exposed surface of the device.

One or more cushion packages may be used as a packaging material for an electronic device, such as a headset, AR/VR controller, or other device. The entire device package assembly, including the cushion package, may be recyclable in a standard paper recycling process.

An example cushion package (which may also be referred to as a cushion for conciseness) may include a pair of paper-based layers enclosing an air-filled pocket between the layers. The cushion package may be compliant with complex curvatures, such as the surface of an electronic device. For example, a compliant fit to a head-mounted device may help prevent motion of the device within the packaging during transit. In some examples, the cushion package may form a compliant interference fit with a portion of a device, such as the visor and/or light-receiving surfaces of an AR/VR device. The cushion package may allow plastic foam to be eliminated from the packaging, which previously impeded recycling of the entire package assembly.

The two layers of the cushion package may have different characteristics. The contact layer (the layer that may contact the device) may be thicker than the other (non-contact) layer that does not contact the device. The contact layer may be essentially rigid (e.g., rigid or at least semi-rigid) and may complement the exterior shape of the device. The other (non-contact) layer may only need to be thick enough to be successfully bonded to the contact layer (e.g., around the periphery of the cushion package). A coating, which may include polymer layer such as a polypropylene layer, may be laminated or otherwise attached to the exterior surface of the contact layer to prevent scuffing of the device.

In some examples, the first layer and/or second layer may be (or include) a semi-rigid layer. A semi-rigid layer may be conformable (e.g., readily bendable to conform) to a curved surface of an example electronic device, such as a curved visor of a head-mounted device. In some examples, a semi-rigid layer may include a paper-based material, such as a paper-based card material or other suitable material, having a layer thickness of between 0.25 mm and 5 mm, such as between 0.3 mm and 3 mm, such as between 0.5 mm and 2 mm. In some examples, a semi-rigid layer may include card stock. In some examples, layer thickness range limits may be approximate. A semi-rigid layer may be thicker than a typical sheet of paper, but may be more rigid than a corrugated card layer. In some examples, the first layer may be (or include) a semi-rigid layer, and the second layer may have a thickness (and possibly composition) similar to that of a sheet of paper. In some examples, the first layer may be sufficiently thick as to be effectively embossed. In some examples, the second layer may have a thickness of between approximately 0.08 mm and approximately 3 mm, such as between approximately 0.1 mm and approximately 2 mm.

In some examples, an article (such as an article of manufacture) includes a first layer having a first layer thickness between approximately 0.5 mm and approximately 2 mm, and a second layer having a second layer thickness between approximately 0.1 mm and approximately 2 mm. The first layer may include a semi-rigid layer comprising a paper-based material, such as a paper layer or a card layer. In some examples, the second layer may be less rigid than the first layer, and may also include a paper-based material. The article may include a cushion portion including a gas-filled enclosure located between the first layer and the second layer. The second layer may be bonded to the first layer within a peripheral region that extends, in whole or in part, around the cushion portion. The peripheral region may help seal a gas such as air within the gas-filled enclosure. The article may conformable to a curved surface, and may readily bend in one or more directions. For example, a person may readily bend the assembly by holding a portion in one hand and pushing another portion with finger. For example, a finger force of 10 N may induce an appreciable bend in the article. The first layer and the second layer may each comprise cellulose fibers, and may each be a paper-based material such as a paper layer or a card layer. The first layer and the second layer may be spaced apart by a gap thickness within the cushion portion to help define the enclosure. The gap thickness may be between approximately 0.1 mm and approximately 5 mm, and the gap thickness may be generally uniform within the cushion portion (for example, away from the edge portions if the cushion package is laid flat on a supportive surface). The gas-filled enclosure may be a sealed enclosure, such that attempting to compress the enclosure may increase the pressure of gas within the enclosure. In some examples, the cushion portion includes an embossed portion of the second layer spaced apart from the first layer. The article may be sized to cover a light-receiving surface of a head-mounted device, such as a visor or lens surface, when the device is packaged. The second layer thickness may be less than approximately half the first layer thickness. The article may recyclable within a paper recycling process, such as a conventional paper recycling process configured to receive paper-based items such as newspaper, cardboard, or the like. In some examples, the article may include less than 1% by weight of a material that is not recyclable in a paper recycling process, such as a synthetic polymer.

### EXAMPLE EMBODIMENTS

### Example 1

An article may include a first layer having a first layer thickness between 0.5 mm and 2 mm, the first layer being a semi-rigid layer including a paper-based material; and a second layer having a second layer thickness between 0.1 mm and 2 mm, where: the article includes a cushion portion; the cushion portion includes a gas-filled enclosure located between the first layer and the second layer; the second layer is bonded to the first layer within a peripheral region that extends around the cushion portion; and the article is conformable to a curved surface.

### Example 2

The article of example 1, where the first layer and the second layer each include cellulose fibers.

### Example 3

The article of any of examples 1 or 2, where the first layer and the second layer are spaced apart by a gap thickness within the cushion portion, the gap thickness is between approximately 0.1 mm and approximately 5 mm, and the gap thickness is generally uniform within the cushion portion.

### Example 4

The article of any of examples 1-3, where the gas-filled enclosure is a sealed enclosure.

### Example 5

The article of any of examples 1-4, where the cushion portion includes an embossed portion of the second layer spaced apart from the first layer.

### Example 6

The article of any of examples 1-5, where the article is sized to cover a light-receiving surface of a head-mounted apparatus.

### Example 7

The article of any of examples 1-6, where the first layer thickness is approximately equal to the second layer thickness.

### Example 8

The article of any of examples 1-7, where the second layer thickness is less than approximately half the first layer thickness.

### Example 9

The article of any of examples 1-8, where the article is recyclable within a paper recycling process.

### Example 10

The article of any of examples 1-9, where the article includes less than 1% by weight of synthetic polymers.

### Example 11

The article of any of examples 1-10, where the first layer has an exterior surface and an inner surface, the inner surface of the first layer is bonded to the second layer within the peripheral region, and the article further includes a coating extending over at least a portion of the exterior surface of the first layer.

### Example 12

The article of example 11, where the coating includes a polyolefin.

### Example 13

The article of examples 11 or 12, where the coating includes polypropylene.

### Example 14

The article of any of examples 11-13, where the coating includes cellulose.

### Example 15

The article of any of examples 11-14, where the coating has a grooved external surface profile.

### Example 16

The article of any of examples 11-15, where the coating has a coating thickness of less than 100 microns.

### Example 17

The article of any of examples 11-16, where the article further includes a second coating extending over at least a part of the second layer.

### Example 18

A method may include embossing a layer to form an embossed portion of the layer within an non-embossed portion of the layer, bonding the non-embossed portion of the layer to an additional layer to form a peripheral region surrounding an enclosure formed between the embossed portion of the layer and the additional layer, and optionally trimming the peripheral region to match a surface portion of an electronic device, where the layer and the additional layer each include cellulose fibers and are recyclable within a paper recycling process.

### Example 19

The method of example 18, further including forming a polypropylene layer on at least a portion of the layer.

### Example 20

An example method may include packaging an electronic device within a package assembly including a box, a device receptacle, and a cushion package, where the cushion package protects a surface portion of the electronic device and the package assembly is entirely recyclable using a paper recycle process.

Materials, process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An article, comprising:
a first layer having a first layer thickness between 0.5 mm and 2 mm, the first layer being a semi-rigid layer comprising a paper-based material; and
a second layer having a second layer thickness between 0.1 mm and 2 mm,
wherein:
the article comprises a cushion portion;
the cushion portion comprises a gas-filled enclosure located between the first layer and the second layer;
the second layer is bonded to the first layer within a peripheral region that extends around the cushion portion; and
the article is conformable to a curved surface.

2. The article of claim 1, wherein the first layer and the second layer each comprise cellulose fibers.

3. The article of claim 1, wherein:
the first layer and the second layer are spaced apart by a gap thickness within the cushion portion;
the gap thickness is between approximately 0.1 mm and approximately 5 mm; and
the gap thickness is generally uniform within the cushion portion.

4. The article of claim 1, wherein the gas-filled enclosure is a sealed enclosure.

5. The article of claim 1, wherein the cushion portion comprises an embossed portion of the second layer spaced apart from the first layer.

6. The article of claim 1, wherein the article is sized to cover a light-receiving surface of a head-mounted apparatus.

7. The article of claim 1, wherein the first layer thickness is approximately equal to the second layer thickness.

8. The article of claim 1, wherein the second layer thickness is less than approximately half the first layer thickness.

9. The article of claim 1, wherein the article is recyclable within a paper recycling process.

10. The article of claim 1, wherein the article comprises less than 1% by weight of synthetic polymers.

11. The article of claim 1, wherein:
the first layer has an exterior surface and an inner surface;
the inner surface of the first layer is bonded to the second layer within the peripheral region; and
the article further comprises a coating extending over at least a portion of the exterior surface of the first layer.

12. The article of claim 11, wherein the coating comprises a polyolefin.

13. The article of claim 11, wherein the coating comprises polypropylene.

14. The article of claim 11, wherein the coating comprises cellulose.

15. The article of claim 11, wherein the coating has a grooved external surface profile.

16. The article of claim 11, wherein the coating has a coating thickness of less than 100 microns.

17. The article of claim 11, wherein the article further comprises a second coating extending over at least a part of the second layer.

18. A method comprising:
embossing a layer to form an embossed portion of the layer within an non-embossed portion of the layer;
bonding the non-embossed portion of the layer to an additional layer to form a peripheral region, the peripheral region surrounding an enclosure formed between the embossed portion of the layer and the additional layer; and
trimming the peripheral region to match a surface portion of an electronic device,
wherein the layer and the additional layer each comprise cellulose fibers and are recyclable within a paper recycling process.

19. The method of claim 18, further comprising forming a polypropylene layer on at least a portion of the layer.

20. A method comprising:
packaging an electronic device within a package assembly comprising a box, a device receptacle, and a cushion package,
wherein:
the cushion package protects a surface portion of the electronic device; and
the package assembly is entirely recyclable using a paper recycle process.
